(19) United States
(12) Patent Application Publication
(10) Pub. No.: US 2023/0409709 A1
(43) Pub. Date: Dec. 21, 2023

(54) IMAGE FORMING APPARATUS, VIRUS QUARANTINE SYSTEM, AND VIRUS QUARANTINE METHOD

(71) Applicant: SHARP KABUSHIKI KAISHA, Sakai City (JP)

(72) Inventor: KAZUHISA KUBOTA, Sakai City (JP)

(21) Appl. No.: 18/207,213

(22) Filed: Jun. 8, 2023

(30) Foreign Application Priority Data
Jun. 20, 2022 (JP) 2022-099025

(51) Int. Cl. G06F 21/56; G06F 21/60

(52) U.S. Cl. CPC G06F 21/56; G06F 21/608

(57) ABSTRACT

An image forming apparatus includes a controller that executes virus quarantine using a pattern file, and a storage that stores the pattern file. The controller, when being connected to a network, determines whether the pattern file stored in the storage is updatable, and when it determined that the pattern file is updatable, the controller updates the pattern file, and executes virus quarantine by using the updated pattern file.

### BACKGROUND OF THE INVENTION

### Field of the Invention

The present disclosure relates to an image forming apparatus and the like.

### Description of the Background Art

As a general method of preventing infection by a computer virus (hereinafter, simply referred to as a “virus”), there is a method in which an anti-virus program is installed in an information processing apparatus such as a computer terminal, and a virus that has invaded is removed by periodically executing virus scanning. Although this method is a useful method of suppressing virus infection on the side of the information processing apparatus, it is necessary to update a pattern file to be provided by a vendor or the like of the anti-virus program for countermeasures against a virus of a new type.

By the way, a multifunction device in which a plurality of functions such as a fax function, a printer function, and a scanner function are integrated is also one of information processing apparatuses. Since jobs to be executed by a multifunction device include a job achievable by communicating with an external device connected via a communication network such as a network, for example, data themselves to be handled by the multifunction device, and the external device connected via the multifunction device may also become a target of virus attack.

For this reason, some multifunction devices include a function of executing virus scanning for data to be handled by the multifunction device, an application program installed in the multifunction device, a system, and stored data. In a multifunction device as described above, it is also necessary to periodically update a pattern file for executing virus scanning in order to keep the multifunction device in a safe state, and a function of updating the pattern file at a predetermined timing is prepared by a device administrator or the like.

For example, an image forming apparatus is known, in which, when recovered from an energy saving mode, confirmation is made as to whether a pattern file is of a latest version by communicating with a server, and in a case where it is confirmed that the pattern file is not of the latest version, the pattern file is updated to a latest state.

In many cases, a multifunction device shifts to an energy saving mode within a few seconds (within about 5 seconds) when an operation is not performed, and in many cases, an operation (recovery from the energy saving mode) is performed immediately after the multifunction device shifts to the energy saving mode. Therefore, as described in the conventional technique, when it is configured in such a way that the multifunction device shifts to an energy saving mode, and a pattern file is updated each time when the multifunction device is recovered from the energy saving mode, a usage load of the multifunction device on an arithmetic device is large, which may affect an operation of the user.

Unlike other information processing apparatuses such as a computer terminal, and a smartphone, a multifunction device may be frequently used without being connected to a network. Therefore, even when an operation of updating a pattern file is performed each time when the multifunction device is recovered from the energy saving mode, an update error may occur by non-connection to the network.

An object of the present disclosure is to provide an image forming apparatus and the like capable of reducing a processing load pertaining to update of a pattern file, and securely performing update of the pattern file.

### SUMMARY OF THE INVENTION

In order to solve the above problem, an image forming apparatus according to the present disclosure includes a controller that executes virus quarantine using a pattern file; and a storage that stores the pattern file. The controller determines, when being connected to a network, whether the pattern file stored in the storage is updatable, and when it is determined that the pattern file is updatable, the controller updates the pattern file, and executes virus quarantine by using the updated pattern file.

Further, a virus quarantine system according to the present disclosure includes a server that provides a pattern file; and an image forming apparatus that acquires the pattern file via a network. The image forming apparatus includes a controller that executes virus quarantine using the pattern file, and a storage that stores the pattern file. The controller, when being connected to a network, determines whether the pattern file stored in the storage is updatable, and when it is determined that the pattern file is updatable, the controller updates the pattern file, and executes virus quarantine by using the updated pattern file. The server stores an update history on the pattern file in the image forming apparatus.

Further, a virus quarantine method according to the present disclosure includes: executing virus quarantine by using a pattern file; and storing the pattern file. When being connected to a network, it is determined whether the stored pattern file is updatable, and when it is determined that the pattern file is updatable, the pattern file is updated, and virus quarantine is executed by using the updated pattern file.

According to the present disclosure, it is possible to provide an image forming apparatus and the like that reduces a processing load pertaining to update of a pattern file, and securely performing update of the pattern file.

### BRIEF DESCRIPTION OF THE DRAWINGS

FIG. 1 is a diagram illustrating an overall configuration of a virus quarantine system according to a first embodiment.

FIG. 2 is a functional configuration diagram of a multifunction device according to the first embodiment.

FIG. 3 is a diagram illustrating a data configuration example of an update information table.

FIG. 4 is a diagram illustrating a data configuration example of a history information table.

FIG. 5 is a functional configuration diagram of a management server according to the first embodiment.

FIG. 6 is a diagram illustrating a data configuration example of an update history table.

FIG. 7 is a flowchart illustrating a flow of processing according to the first embodiment.

FIG. 8 is a flowchart illustrating a flow of processing according to the first embodiment.

FIG. 9 is a diagram illustrating an operation example according to the first embodiment.

FIGS. 10A to 10C are diagrams illustrating an operation example according to the first embodiment.

FIG. 11 is a diagram illustrating an operation example according to the first embodiment.

FIG. 12 is a diagram illustrating an operation example according to the first embodiment.

FIG. 13 is a diagram illustrating a data configuration example of a predetermined-period-related management table.

FIG. 14 is a flowchart illustrating a flow of processing according to a second embodiment.

FIGS. 15A and 15B are diagrams illustrating an operation example according to the second embodiment.

FIG. 16 is a functional configuration diagram of a multifunction device according to a third embodiment.

FIG. 17 is a flowchart illustrating a flow of processing according to the third embodiment.

FIG. 18 is a diagram illustrating an operation example according to the third embodiment.

FIG. 19 is a flowchart illustrating a flow of processing according to a fourth embodiment.

### DESCRIPTION OF THE PREFERRED EMBODIMENTS

In the following, embodiments according to the present disclosure are described with reference to the drawings. In the present disclosure, a multifunction device capable of executing a job in each operation mode such as a fax mode, a print mode, and a scan mode is described as a configuration example of an image forming apparatus. Note that, the following embodiments are an example for describing the present disclosure, and the technical scope of the description defined in the claims is not limited to the following description.

### 1. First Embodiment

A first embodiment is an embodiment in which, when a device is connected to a network, determination is made as to whether a pattern file stored in a storage is updatable, and when it is determined that the pattern file is updatable, the pattern file is updated, and virus quarantine is executed by using the updated pattern file.

Herein, a pattern file according to the present disclosure is a file (database) recorded with characteristics of a virus for use in virus quarantine (hereinafter, also referred to as virus scanning) for data to be handled by a multifunction device, an application program installed in a multifunction device, a system, and stored data. An anti-virus application executes virus scanning for target data by pattern matching with a pattern file. The pattern file may be desirably updated periodically in order to cope with a new virus, and the pattern file for updating is provided from a vendor who is a manufacturer or a distributor of the anti-virus application (program) by downloading via a network, or distribution of a storage medium recorded with the pattern file. In the following description, it is assumed that a pattern file for updating is provided by downloading from a server (vendor server) prepared by a vendor via a network.

1.1 Functional Configuration

1.1.1 Overall Configuration

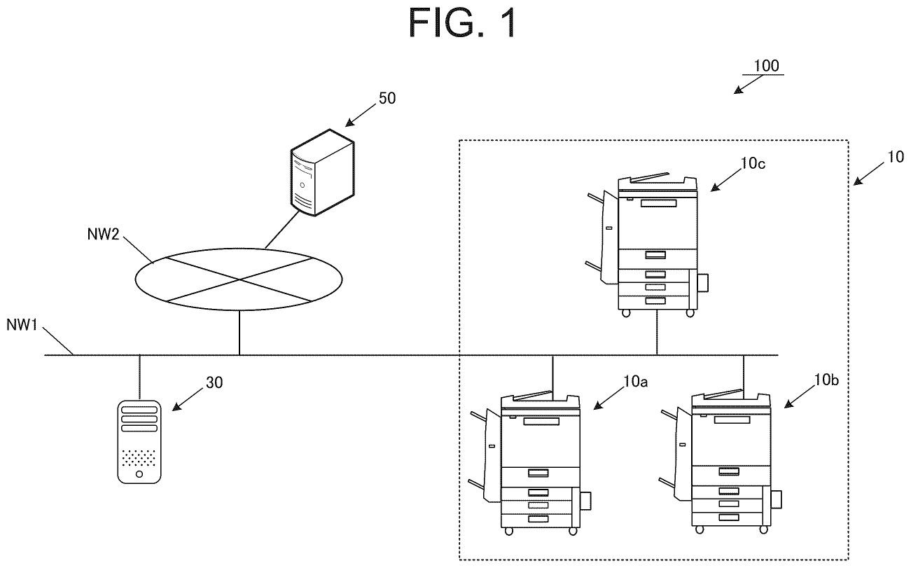

FIG. 1 is a diagram schematically illustrating an overall configuration of a virus quarantine system 100 according to the first embodiment. The virus quarantine system 100 includes multifunction devices 10a, 10b, and 10c as image forming apparatuses, a management server 30 as a server, and a vendor server 50.

The multifunction devices 10a, 10b, and 10c, and the management server 30 are connected via a network NW1, such as a local area network (LAN), for example, and are configured to be mutually communicable. The management server 30 is also connected to the vendor server 50 to be mutually communicable via the network NW1, a network NW2 such as the Internet, or the like, and is configured in such a way as to be able to acquire a pattern file for updating from the vendor server 50.

While the network NW1 illustrated in FIG. 1 is connected to the three multifunction devices 10, namely, the multifunction devices 10a, 10b, and 10c, the number of multifunction devices 10 may be one, or multifunction devices 10 of more than three may be connected to the network NW1. Note that, while the multifunction device 10 is described as an example of an image forming apparatus, the image forming apparatus is not limited to the multifunction device 10, but may be, for example, a copying machine, a fax machine, a printer, or the like. An information processing apparatus such as a computer terminal capable of outputting an instruction to execute a print job, a scan job, and the like for the multifunction device 10 may also be connected to the network NW1.

1.1.2 Regarding Multifunction Devices 10 (10a, 10b, and 10c)

Next, the multifunction devices 10 (10a, 10b, and 10c) are described. Since the multifunction devices 10a, 10b, and 10c can have the same configuration, unless it is necessary to distinguish the multifunction devices one from another, the multifunction devices are denoted as the multifunction devices 10.

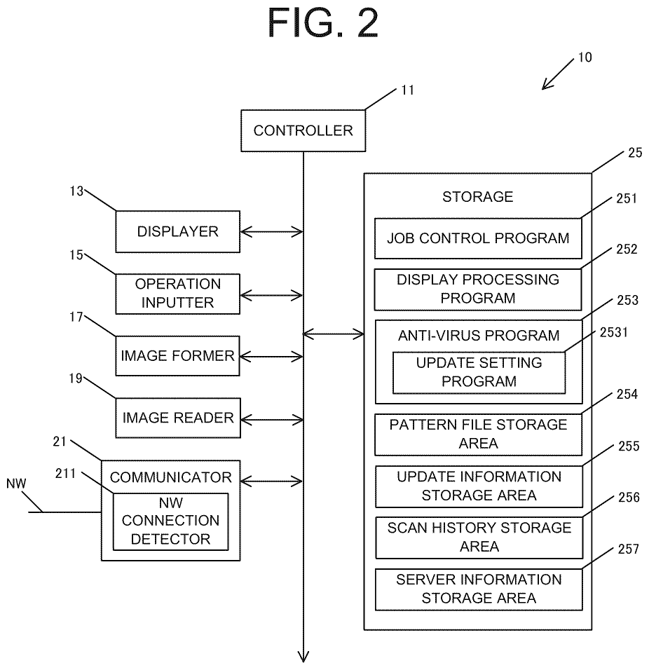

FIG. 2 is a functional configuration diagram of the multifunction device 10. The multifunction device 10 includes a controller 11, a displayer 13, an operation inputter 15, an image former 17, an image reader 19, a communicator 21, and a storage 25.

The controller 11 controls the entirety of the multifunction device 10. The controller 11 is configured of, for example, one or more arithmetic devices (such as a central processing unit (CPU)). The controller 11 achieves its function by reading and executing various programs stored in the storage 25.

The displayer 13 displays various pieces of information to a user or the like. The displayer 13 can be configured of, for example, a liquid crystal display (LCD), an organic electro-luminescence (EL) display, or the like.

The operation inputter 15 accepts an input of information from the user or the like. The operation inputter 15 can be configured as a touch panel display that allows an input via the displayer 13. In this case, as an input method to a touch panel display, for example, a resistive film method, an infrared method, an electromagnetic induction method, a capacitance method, and the like can be employed.

The image former 17 forms an image based on image data on paper as a recording medium. The image former 17 feeds paper from an unillustrated paper feeder, forms an image based on image data on the paper, and then discharges the paper to an unillustrated paper discharger. The image former 17 can be configured of, for example, a laser printer or the like using an electrophotographic method. In this case, the image former 17 performs image formation by using toner supplied from unillustrated toner cartridges associated with toner colors (e.g., cyan, magenta, yellow, and black).

The image reader 19 generates image data by scanning and reading a document image. The image reader 19 can be configured, for example, as a scanner device including an image sensor such as a charge coupled device (CCD), and a contact image sensor (CIS). There is no restriction on a configuration of the image reader 19, as long as the image reader 19 is configured to generate image data by reading reflected light from a document image with use of an image sensor.

The communicator 21 includes an interface for wired/wireless communication with another device such as the management server 30 via the network NW1 such as a LAN, a wide area network (WAN), the Internet, and a fax line (telephone line). The communicator 21 also includes an NW connection detector 211 that detects connection to the network NW1. The NW connection detector 211 can be configured, for example, as a connection connector for an Ethernet (registered trademark) cable (e.g., a LAN cable) in accordance with a TCP/IP protocol, or as a part of a Wi-Fi (registered trademark) antenna. Note that, the NW connection detector 211 may be a hardware resource, a software resource, or combination of these resources, as long as it is possible to detect connection of the multifunction device 10 to the network NW1, and output, to the controller 11, a signal (connection signal) indicating that the multifunction device 10 is connected.

The storage 25 stores various programs necessary for an operation of the multifunction device 10, and various pieces of data. The storage 25 can be configured of a storage device such as, for example, a random access memory (RAM), a hard disk drive (HDD), a solid state drive (SSD), and a read only memory (ROM).

In the first embodiment, the storage 25 stores therein a job control program 251, a display processing program 252, and an anti-virus program 253, and secures a pattern file storage area 254, an update information storage area 255, a scan history storage area 256, and a server information storage area 257.

The job control program 251 is a program to be read by the controller 11 to control processing in each operation mode, such as a fax mode, a print mode, and a scan mode on a job basis. After reading the job control program 251, the controller 11 functions as a job executor, and can execute a job by controlling the displayer 13, the operation inputter 15, the image former 17, the image reader 19, the communicator 21, and the like.

The display processing program 252 is a program to be read by the controller 11 when controlling screen display on the displayer 13. After reading the display processing program 252, the controller 11 displays, on the displayer 13, for example, a setting screen for accepting an input such as various setting values pertaining to execution of a job, an execution instruction, and a termination instruction, a basic screen such as a home screen for displaying the setting screen in a switchable manner, various setting screens pertaining to virus scan settings to be described later, and the like.

The anti-virus program 253 is a program to be read by the controller 11 when update of a pattern file or virus scanning is executed. The controller 11 functions as an anti-virus application by reading the anti-virus program 253. After reading the anti-virus program 253, the controller 11 executes virus scanning for data to be handled by the multifunction device 10 by pattern matching with a pattern file stored in the pattern file storage area 254, an application program to be installed in the multifunction device 10, a system, and stored data.

The anti-virus program 253 also includes an update setting program 2531. After reading the update setting program 2531, the controller 11 accepts, via a virus scan setting screen to be described later, presence or absence of execution of periodic update (pattern update) of a pattern file, update settings including an update date and time of a pattern file and the like, presence or absence of execution of virus scanning, and parameter settings relating to virus scanning including an execution date and time of virus scanning and the like.

The pattern file storage area 254 is a storage area that stores a pattern file acquired from the management server 30.

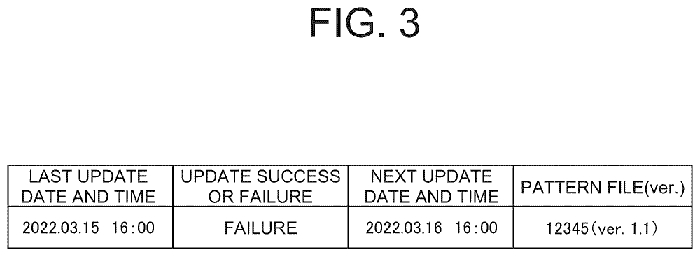

The update information storage area 255 is a storage area that stores information relating to an update history on a pattern file, for example, as an update information table. Herein, information to be stored in the update information storage area 255 is described by using FIG. 3. FIG. 3 is a diagram illustrating a data configuration example of the update information table.

The update information table includes, as items to be stored, a last update date and time, an update success or failure, a next update date and time, and a pattern file (ver.).

The last update date and time indicates a date and time when update of a pattern file has been performed. The date and time to be stored as the last update date and time is an update date and time pertaining to periodic update that is set in advance, or update that has been performed by using connection to a network, as a trigger, and is stored regardless of whether the update is successful or not. The example in FIG. 3 indicates that the last update of a pattern file has been performed at “2022.03.15 16:00”.

The update success or failure indicates whether update of a pattern file that has been performed at the last update date and time is successful or not. The example in FIG. 3 indicates that update of a pattern file that has been performed at the last update date and time “2022.03.15 16:00” has failed, and, for example, indicates that network connection is disconnected, and update of the pattern file has failed, because of a reason such as a power outage caused by shifting to the energy saving mode, a power outage of the device caused by operating a power switch or the like, or removal of an Ethernet (registered trademark) cable from a connection connector.

The next update date and time indicates a date and time when a pattern file is updated next time. For example, in a case where the update date and time pertaining to periodic update is set to “yyyy.mm.dd. 16:00” in updating settings of a pattern file to be described later, “2022.03.16 16:00” being one day after (after 24 hours) since the last update date and time “2022.03.15 16:00” becomes the next update date and time.

The pattern file (ver.) indicates the name and the version of a pattern file stored in the pattern file storage area 254. In the pattern file (ver.), particularly, the version is used to search for an updateable pattern file in the management server 30. FIG. 3 is an example indicating that the name of the pattern file stored in the pattern file storage area 254 is “12345”, and its version is “ver. 1.1”. Note that, processing pertaining to update of a pattern file is described later.

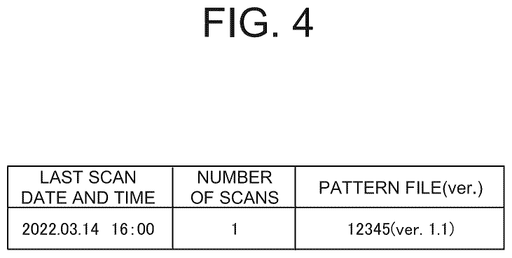

Referring back to FIG. 2, the scan history storage area 256 is a storage area that stores, for example, as a history information table, information relating to an execution history on virus scanning. Herein, information to be stored in the scan history storage area 256 is described by using FIG. 4. FIG. 4 is a diagram illustrating a data configuration example of the history information table.

The history information table includes, as items to be stored, a last scan date and time, the number of scans, and a pattern file (ver.).

The last scan date and time indicates a date and time when virus scanning has been executed most recently. The date and time to be stored as the last scan date and time is a latest execution date and time of virus scanning that has been executed by periodic update, or update that has been performed by using connection to a network, as a trigger, or by using a pattern file that is not updated. FIG. 4 is an example in which virus scanning has been executed based on a pattern file updated at “2022.03.14 16:00”, which corresponds to a day before the last update date and time “2022.03.15 16:00” illustrated in FIG. 3. This is an example in which virus scanning that has been executed at “2022.03.14 16:00” is stored as the latest execution date and time, because update of the pattern file at the last update date and time “2022.03.15 16:00” illustrated in FIG. 3 has failed.

The number of scans indicates the number of times of virus scanning that has been executed by the pattern file indicated by the pattern file (ver.). The pattern file (ver.) indicates the file name of the pattern file used for virus scanning, and a version of the pattern file.

Referring back to FIG. 2, the server information storage area 257 is a storage area that stores connection information such as an account and an IP address necessary for connection to the management server 30 and the vendor server 50.

1.1.3 Management Server 30

Next, the management server 30 is described. The management server 30 is a server that periodically or irregularly acquires a pattern file for updating from the vendor server 50, and provides the acquired pattern file to the multifunction device 10. The management server 30 is also a management server that manages information relating to an update history and the like of a pattern file in the multifunction device 10 in providing the pattern file to the multifunction device 10.

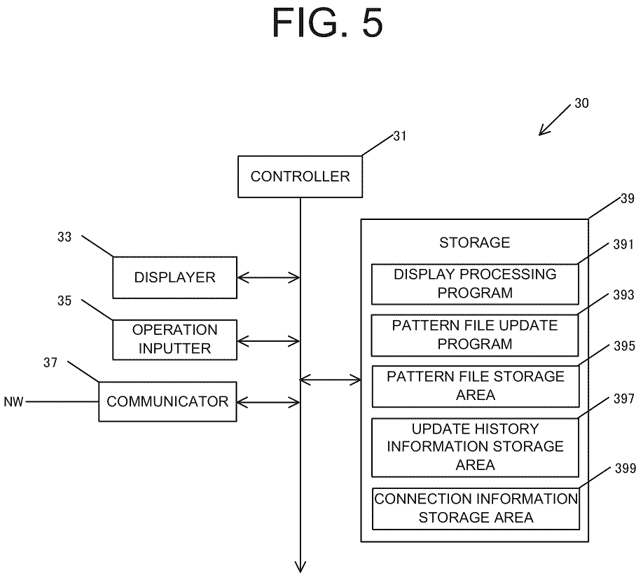

FIG. 5 is a functional configuration diagram of the management server 30. The management server 30 includes a controller 31, a displayer 33, an operation inputter 35, a communicator 37, and a storage 39.

The controller 31 controls the entirety of the management server 30. The controller 31 is configured of, for example, one or more arithmetic devices (such as a CPU). The controller 31 achieves its function by reading and executing various programs stored in the storage 39.

The displayer 33 displays various pieces of information to the user or the like. The displayer 33 can be configured of, for example, an LCD, an organic EL display, or the like.

The operation inputter 35 accepts an input of information from the user or the like. The operation inputter 35 can be configured of, for example, an input means such as a keyboard, a mouse, and a numeric keypad.

The communicator 37 includes an interface for wired/wireless communication with another device such as the multifunction device 10 or the vendor server 50 via the network NW1 or NW2 such as a LAN, a WAN, the Internet, or a fax line (telephone line).

The storage 39 stores various programs necessary for an operation of the management server 30, and various pieces of data. The storage 39 can be configured of a storage device such as, for example, a RAM, an HDD, an SSD, and a ROM.

In the first embodiment, the storage 39 stores a display processing program 391, and a pattern file update program 393, and secures a pattern file storage area 395, an update history information storage area 397, and a connection information storage area 399.

The display processing program 391 is a program to be read by the controller 31 when controlling screen display on the displayer 33. After reading the display processing program 391, the controller 31 displays, on the displayer 33, an unillustrated management screen for managing an update history on a pattern file in the multifunction device 10, an unillustrated acquisition screen for acquiring a pattern file for updating from the vendor server 50, and the like.

The pattern file update program 393 is a program to be read by the controller 31 when executing processing relating to update of a pattern file in the multifunction device 10 (10a, 10b, 10c) to be managed. After reading the pattern file update program 393, for example, the controller 31 acquires a pattern file for updating from the vendor server 50, and replies to an inquiry relating to the pattern file for updating from the multifunction device 10 to be described later. In addition, after reading the pattern file update program 393, the controller 31 manages, as history information, information relating to update of a pattern file for each multifunction device 10 (10a, 10b, 10c).

The pattern file storage area 395 is a storage area that stores a pattern file for updating acquired from the vendor server 50.

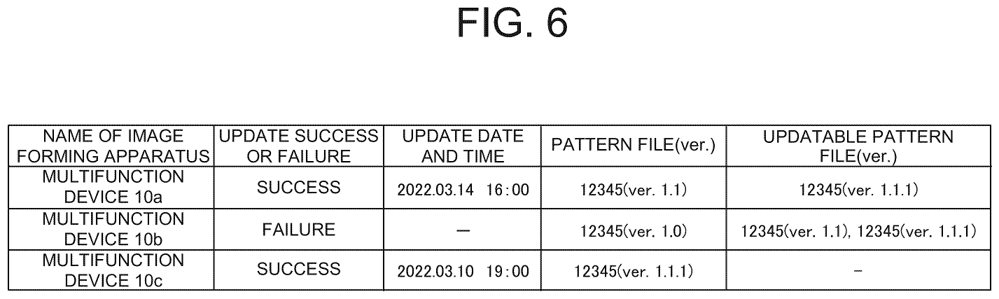

The update history information storage area 397 is a storage area that stores, for example, as an update history table, information relating to an update history or the like on a pattern file in the multifunction device 10. Herein, information to be stored in the update history information storage area 397 is described by using FIG. 6. FIG. 6 is a diagram illustrating a data configuration example of the update history table.

The update history table includes, as items to be stored, a name of the image forming apparatus, an update success or failure, an update date and time, a pattern file (ver.), and an updateable pattern file (ver.).

The name of the image forming apparatus indicates the name of the image forming apparatus to be managed by the management server 30. FIG. 6 is an example in which the management server 30 manages the three multifunction devices 10 (10a, 10b, and 10c), as image forming apparatuses. The management server 30 stores information relating to an update history and the like on a pattern file regarding each of the multifunction devices 10 (10a, 10b, and 10c) indicated by the name of the image forming apparatus.

The update success or failure indicates a success or a failure of update of a pattern file that has been performed in the multifunction device 10. The update date and time indicates the date and time when update of a pattern file has been performed in the multifunction device 10. The pattern file (ver.) indicates the name and the version of the updated pattern file. The updatable pattern file (ver.) indicates the name and the version of a pattern file providable for updating, regarding the pattern file acquired from the vendor server 50.

For example, an update history indicated by the name of the image forming apparatus “multifunction device 10a” in FIG. 6 indicates that update of the pattern file“12345 (ver. 1.1)” that has been performed at the update date and time “2022.03. 14 16:00” is “success”. Further, the update history indicates that a pattern file providable as a pattern file for updating is present in the management server 30 with respect to the pattern file, and that the name and the version of the pattern file is “12345 (ver. 1.1.1)”.

Referring back to FIG. 5, the connection information storage area 399 is a storage area that stores connection information such as an account and an IP address necessary for connection to the multifunction devices 10 (10a, 10b, and 10c) and the vendor server 50.

1.1.4 Regarding Vendor Server 50

The vendor server 50 is a server to be managed by a vendor that performs a service of providing the anti-virus program 253. The vendor server 50 can be, for example, configured of an information processing apparatus such as a computer terminal, and can be configured as a service server that provides a pattern file for updating. The vendor server 50 may be a pull-type service server that transmits an associated pattern file to the management server 30 in response to a request for acquiring a pattern file from the management server 30, or may be a push-type service server that actively distributes an updatable pattern file by the vendor server 50, and a functional configuration of the vender server is not specifically limited.

1.2 Flow of Processing

1.2.1 Flow of Processing of Multifunction Device 10

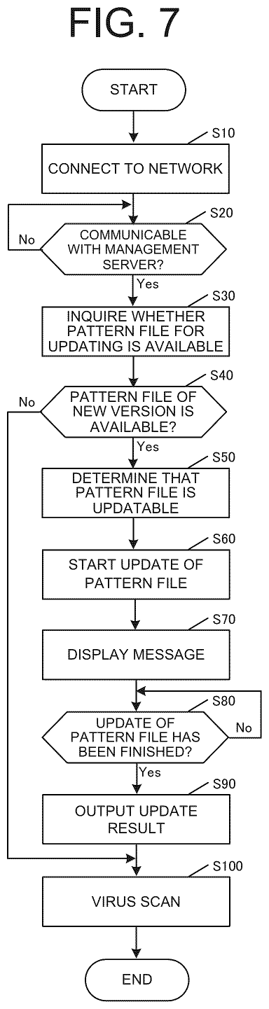

Next, a flow of processing of the multifunction device 10 according to the first embodiment is described by using the flowchart in FIG. 7. Note that, the processing to be described herein is processing to be performed by causing the controller 11 of the multifunction device 10 to read the anti-virus program 253 and the like.

When being connected to the network NW1, the controller 11 of the multifunction device 10 determines whether it is possible to communicate with the management server 30 (step S10→step S20). Note that, the controller 11 can recognize connection to the network NW1 by acquiring a connection signal output from the NW connection detector 211. Then, the controller 11 determines whether it is possible to communicate with the management server 30 by executing a ping command, for example, based on IP address information and the like of the management server 30 stored in the server information storage area 257.

When it is determined that communication with the management server 30 is possible, the controller 11 inquires the management server 30 whether a pattern file for updating is available (step S20; Yes→step S30). In this case, the controller 11 can notify the management server 30 of a version of a pattern file (ver.) stored in the update information storage area 255, and determine whether a pattern file for updating is available by determining whether the management server 30 has a pattern file of a version newer than the version. On the other hand, the controller 11 may inquire the management server 30 whether a pattern file for updating is available, and determine whether the pattern file for updating is available by comparing the pattern file (ver.) in the update history table stored in the update history information storage area 397 by the management server 30 with an updatable pattern file (ver.). On the other hand, in a case where it is determined that communication with the management server 30 is not possible, the controller 11 waits until communication with the management server 30 becomes possible (step S20; No).

When, as a result of the inquiry to the management server 30, it is determined that a pattern file of a new version is available, the controller 11 determines that the pattern file is updatable (step S40; Yes→step S50). On the other hand, when it is determined that a pattern file of a new version is not available, the controller 11 shifts the processing to step S100, and executes virus scanning by using a pattern file (not updated) stored in the pattern file storage area 254 (step S40; No→step S100).

After determining that the pattern file is updatable, the controller 11 acquires the pattern file for updating from the management server 30, and starts update of the pattern file (step S60).

Note that, during update of the pattern file, the controller 11 can display, on the displayer 13, a message indicating that the pattern file is being updated (step S70).

Then, the controller 11 determines whether update of the pattern file has been finished (step S80). In a case where it is determined that update of the pattern file has been finished, the controller 11 outputs the update result to the management server 30 (step S80; Yes→step S90). On the other hand, in a case where it is determined that update of the pattern file has not been finished, the controller 11 continues the processing (step S80; No).

The controller 11 executes virus scanning by using the pattern file, and terminates the processing (step S100).

1.2.2 Flow of Processing of Management Server 30

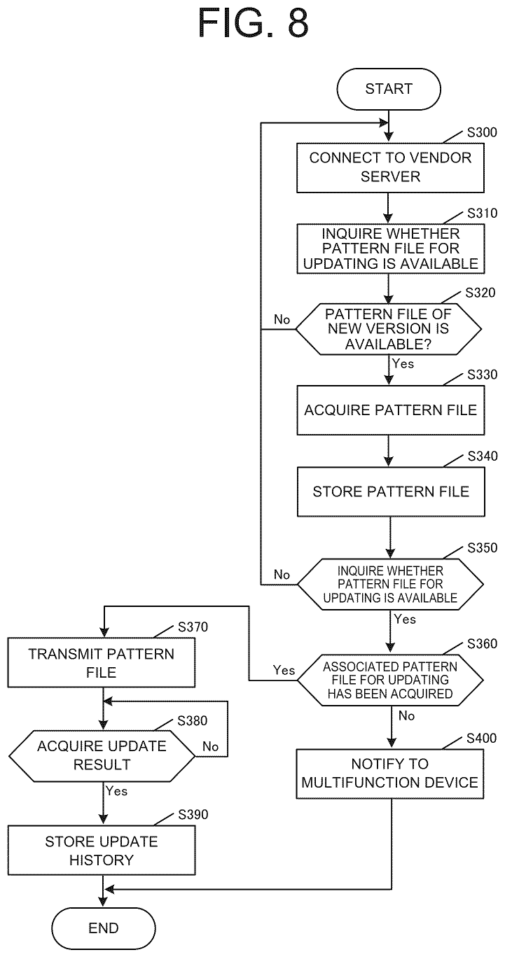

Next, a flow of processing of the management server 30 according to the first embodiment is described by using the flowchart in FIG. 8. Note that, the processing to be described herein is processing to be performed by causing the controller 31 of the management server 30 to read the pattern file update program 393 and the like.

The controller 31 of the management server 30 connects the multifunction device 10 to the vendor server 50 (step S300).

The controller 31 inquires the vendor server 50 whether an updatable pattern file is available, based on the update history table to be managed by itself (step S310).

In a case where an updatable pattern file is available, specifically, in a case where a pattern file of a version newer than the version of the pattern file to be managed is available, the controller 31 acquires the pattern file (step S320; Yes→step S330). Note that, in a case where a pattern file of a version newer than the version of the pattern file to be managed is not available, the controller 31 returns the processing to step S300 (step S320; No→step S300).

The controller 31 stores the acquired pattern file in the pattern file storage area 395, and updates the item of the updatable pattern file (ver.) in the update history table (step S340).

Subsequently, the controller 31 determines whether there is an inquiry from the multifunction device 10 as to whether a pattern file for updating is available (step S350). In a case where there is an inquiry from the multifunction device 10 as to whether a pattern file for updating is available, the controller 31 determines whether the associated pattern file for updating has been acquired (step S350; Yes→step S360). In a case where it is determined that the associated pattern file for updating has already been acquired, the controller 31 transmits the pattern file to the multifunction device 10 (step S360; Yes→step S370). On the other hand, in a case where there is no inquiry from the multifunction device 10 as to whether a pattern file for updating is available, the controller 31 returns the processing to step S300 (step S350; No→step S300).

Then, the controller 31 determines whether the update result has been acquired from the multifunction device 10 (step S380). In a case where it is determined that the update result has been acquired, the controller 31 updates the update history table by setting the update result as an update history, and terminates the processing (step S380; Yes→step S390). Note that, in a case where it is determined that the update result has not been acquired from the multifunction device 10, the controller 31 waits until the update result is acquired (step S380; No).

By the way, in a case where it is determined in step S360 that the associated pattern file for updating has not been acquired, the controller 31 notifies the multifunction device 10 to that effect, and terminates the processing (step S360; No→step 400).

1.3 Operation Example

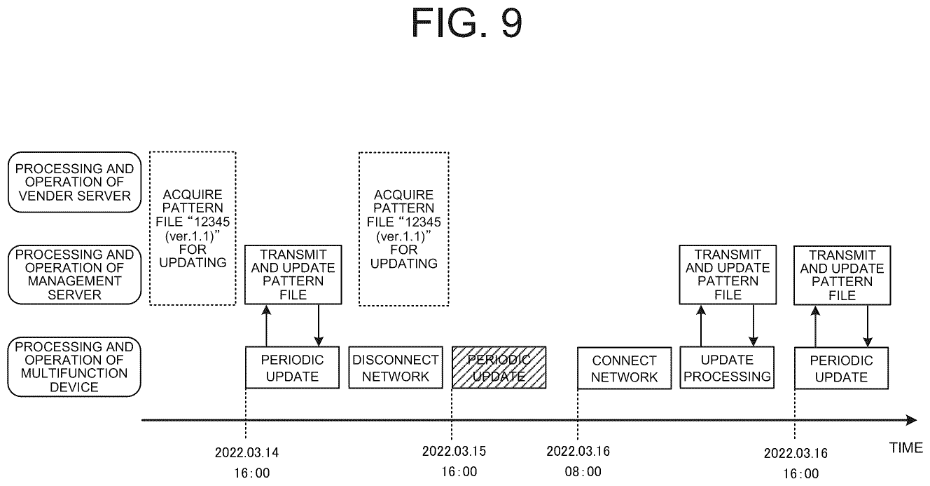

Next, an operation example according to the first embodiment is described. FIG. 9 is a diagram conceptually illustrating a timing sequence of processing and operation among the multifunction device 10, the management server 30, and the vendor server 50 according to the first embodiment.

FIG. 9 illustrates, as an example, processing and operation of updating a pattern file in the multifunction device 10a. Herein, the horizontal axis in FIG. 9 indicates an elapse of time (point of time), and the processing and operation (see the update information table in FIG. 3, and the update history table in FIG. 6) pertaining to update of a pattern file after “2022.03.14 16:00” is mainly described. Note that, description is made based on a premise that the multifunction device 10a stores a pattern file pertaining to a pattern file “12345 (ver. 1.0)” at a time earlier than “2022.03.14 16:00”.

First, the management server 30 acquires a pattern file for updating from the vendor server 50 (at any timing earlier than “2022.03.14 16:00”). At this occasion, it is assumed, that the management server 30 has acquired a pattern file “12345 (ver. 1.1)”, whose version is newer than the version of the pattern file stored in the multifunction device 10a.

The multifunction device 10a performs periodic update of a pattern file at “2022.03.14 16:00”. The multifunction device 10a inquires the management server 30 whether a pattern file for updating is available. The management server 30 notifies the multifunction device 10a to the effect that the management server 30 has the pattern file “12345 (ver. 1.1)”, as the pattern file for updating. Upon receiving the notification, the multifunction device 10a acquires the pattern file “12345 (ver. 1.1)” transmitted from the management server 30, and updates the pattern file. By the update at this time, the pattern file stored in the multifunction device 10a is updated to the pattern file “12345 (ver. 1.1)”.

After the periodic update, it is assumed that network connection is disconnected, for example, because of a reason such as a power outage caused by shifting to the energy saving mode, a power outage of the device caused by operating a power switch or the like, or removal of an Ethernet (registered trademark) cable from a connection connector. When this event continues until a timing of next periodic update, periodic update at “2022.03.15 16:00” is not performed (the update information table in FIG. 3 indicates an update status at this timing).

However, in the first embodiment, it is possible to determine whether a pattern file stored in the pattern file storage area 254 is updatable by using connection to the network NW1, as a trigger, and when it is determined that the pattern file is updatable, the pattern file can be updated.

Specifically, for example, when the multifunction device 10a is connected to the network NW1 at “2022.03.16 08:00”, the multifunction device 10 performs update of the pattern file regardless of the next periodic update date and time “2022.03.16 16 16:00”. At this occasion, when the management server 30 has acquired a pattern file “12345 (ver. 1.1.1)”, whose version is newer than the version of the pattern file “12345 (ver. 1.1)”, the multifunction device 10a acquires the pattern file “12345 (ver. 1.1.1)”, and updates the pattern file. By the update at this time, the pattern file stored in the multifunction device 10a is updated to the pattern file “12345 (ver. 1.1.1)”.

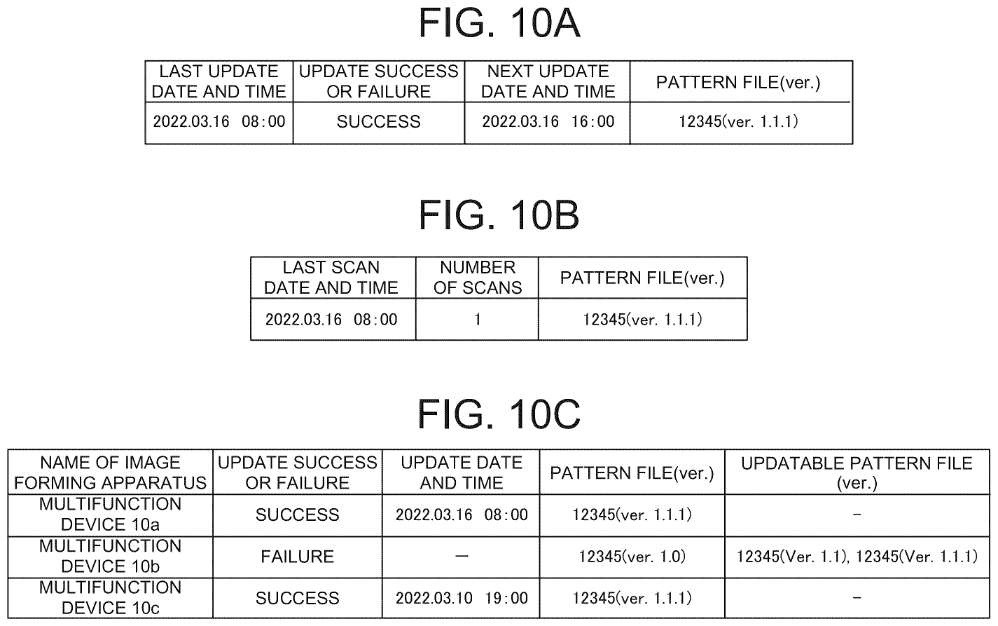

FIGS. 10A to 10C are diagrams illustrating a data configuration example of an update information table (a), a history information table (b), and an update history table (c) after update of the pattern file has been performed at the timing “2022.03.16 08:00” in FIG. 9.

The update information table illustrated in FIG. 10A indicates a manner in which the date and time indicated by the last update date and time has been updated to “2022.03.16 08:00”, the update success or failure has been updated to “success”, the next update date and time has been updated to “2022.03.16 16:00”, and the pattern file (ver.) has been updated to “12345 (ver. 1.1.1) from the example in FIG. 3, respectively.

The history information table illustrated in FIG. 10B indicates a manner in which the date and time indicated by the last scan date and time has been updated to “2022.03.16 08:00”, and the pattern file (ver.) has been updated to “12345 (ver. 1.1.1) from the example in FIG. 4, respectively.

The update history table illustrated in FIG. 10C indicates a manner in which the update success or failure of the multifunction device 10a has been updated to “success”, the date and time indicated by the update date and time has been updated to “2022.03.16 08:00”, the pattern file (ver.) has been updated to “12345 (ver. 1.1.1)”, and the updatable pattern file (ver.)” has been updated to “-” from the example in FIG. 6, respectively.

In this way, in the first embodiment, a pattern file stored in the pattern file storage area 254 can be updated by using connection to the network NW1, as a trigger, and virus scanning using the updated pattern file can be executed.

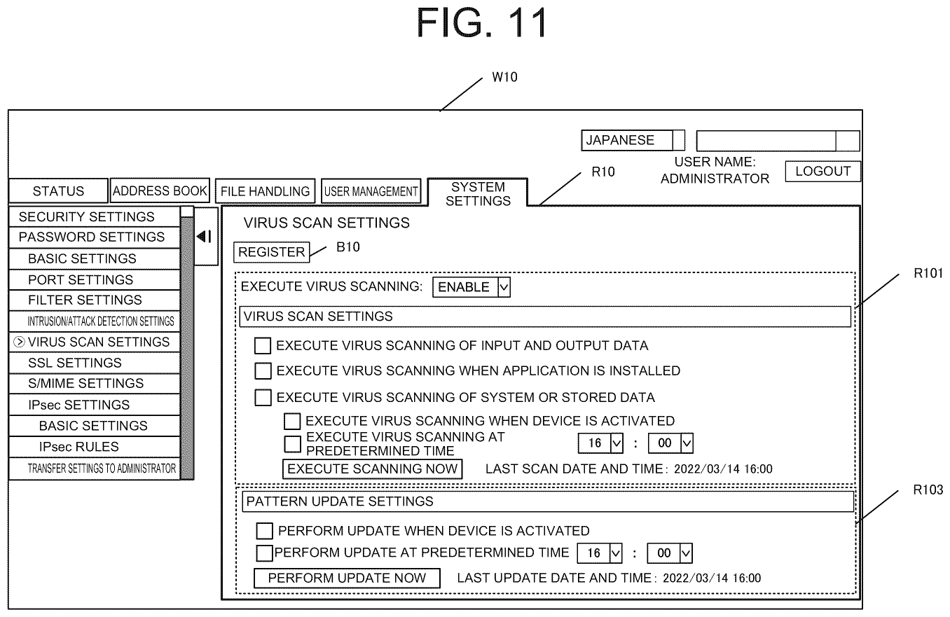

Next, FIG. 11 is a diagram illustrating a configuration example of a setting screen W10 that accepts settings of update settings (pattern update settings) of a pattern file.

The setting screen W10 can be displayed on the displayer 13 via an unillustrated home screen or the like. The setting screen W10 can also be displayed as a Web-UI by utilizing a Web browser on a display device included in a PC, or an unillustrated computer terminal such as a smartphone. In this case, the computer terminal is configured in such a way as to be able to output, to the multifunction device 10, a setting content relating to virus scanning accepted via the Web-UI.

The setting screen W10 illustrated in FIG. 11 includes a virus scan setting area R10, and a registration button B10.

The virus scan setting area R10 includes a virus scan setting subarea R101 that mainly accepts settings relating to virus scanning, and a pattern update setting subarea R103 that accepts update settings of a pattern file.

The virus scan setting subarea R101 includes a pull-down menu that accepts selection of enable or disable of virus scanning, and various checkboxes that accept settings for an execution timing of virus scanning. For example, in a case where the user desires to execute virus scanning at a predetermined time, the user can execute virus scanning at a predetermined time by checking an “execute scanning at a predetermined time” checkbox, and specifying a desired start time of virus scanning via the pull-down menu.

The pattern update setting subarea R103 includes various checkboxes and other items that accept settings for an update timing of a pattern file. For example, in a case where the user desires update (periodic update) of a pattern file at a predetermined time, the user can perform update of the pattern file at the predetermined time by checking a “perform update at a predetermined time” checkbox, and specifying a desired start time of update of the pattern file via the pull-down menu.

Further, the registration button B10 is a button that accepts registration of various parameters that have been accepted via the virus scan setting area R10. When the registration button B10 is selected, the controller 11 stores, in the storage 25, a parameter that has been accepted via the virus scan setting area R10, and uses the parameter for processing of virus scanning or updating a pattern file, or for generation of the update information table pertaining to the example in FIG. 3, and the history information pertaining to the example in FIG. 4.

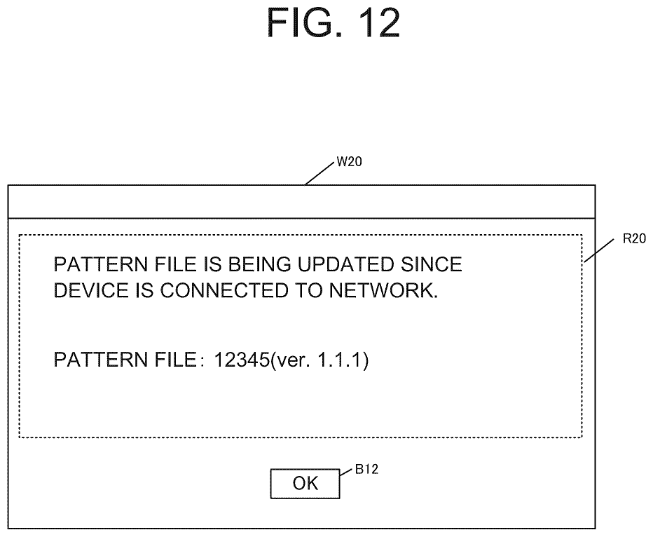

FIG. 12 is a diagram illustrating a configuration example of a message screen W20 to be displayed on the displayer 13 by the controller 11 during update of a pattern file. The message screen W20 includes a message display area R20, and an OK button B12. Note that, display of the message screen W20 is an operation example associated with the processing of step S70 in FIG. 7.

The message display area R20 is a display area that displays to the effect that a pattern file is being updated. FIG. 12 is an example in which, in addition to a message that “a pattern file is being updated since the multifunction device 10 is connected to the network”, as a message to the user, and “the pattern file: 12345 (ver. 1.1.1)” is displayed in the message display area R20, as a pattern file pertaining to update.

The OK button B12 is a button that accepts an approval of the user who has confirmed the message displayed in the message display area R20. When the OK button B12 is selected by the user, the controller 11 can shift the screen to, for example, an unillustrated home screen, a setting screen pertaining to execution of a job, a setting screen pertaining to virus scan settings illustrated in FIG. 11, or the like, while updating the pattern file.

As described above, according to the first embodiment, when the multifunction device is connected to a network, the multifunction device determines whether a pattern file stored in the storage is updatable, and when it is determined that the pattern file is updatable, the multifunction device updates the pattern file, and executes virus scanning by using the updated pattern file. Therefore, it is possible to reduce a processing load pertaining to update of a pattern file, as compared with, for example, a case where the pattern file is updated each time the device is recovered from the energy saving mode. Further, since connection to the network is used as a trigger for update of the pattern file, there is no likelihood that an update error may occur due to non-connection to the network.

### 2. Second Embodiment

A second embodiment is an embodiment in which determination is made as to whether it is necessary to update a pattern file according to determination as to whether a network connection date and time with respect to a reference pattern file update date and time is longer or shorter than a set predetermined period.

2.1 Functional Configuration

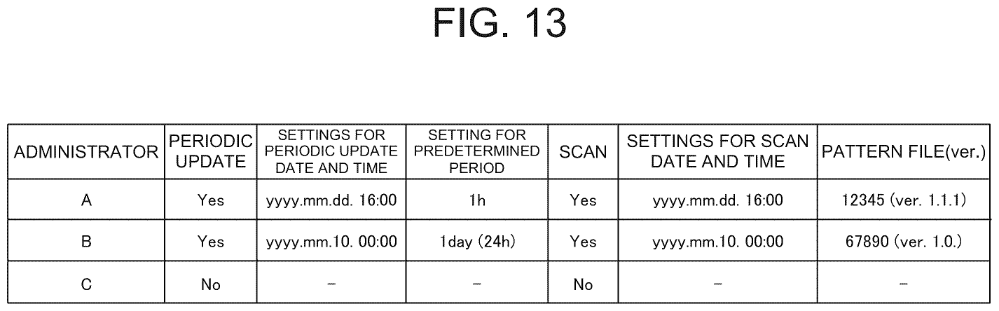

Since a configuration of a virus quarantine system according to the second embodiment can be made substantially the same as that of the virus quarantine system 100 according to the first embodiment, the same reference sign is attached to the same component, and description of its functional configuration is omitted. A multifunction device 10 according to the second embodiment differs from that of the first embodiment in a point that it is possible to control update of a pattern file, based on a predetermined-period-related management table illustrated in FIG. 13.

FIG. 13 is a diagram illustrating a data configuration example of the predetermined-period-related management table according to the second embodiment. The predetermined-period-related management table illustrated in FIG. 13 is an example in which each parameter pertaining to update of a pattern file such as presence or absence of periodic update, settings for a periodic update date and time, settings for a predetermined period, presence or absence of scan settings, settings for a scan date and time, and a pattern file (ver.) is set for each user (administrator).

For example, regarding an administrator A, periodic update “Yes”, settings for a periodic update date and time “yyyy.mm.dd. 16:00”, a predetermined period “1 h”, scan “Yes”, settings for a scan date and time “yyyy.mm.dd. 16:00”, a pattern file (ver.) “12345 (ver. 1.1.1)” are set.

Note that, since setting items such as presence or absence of periodic update, settings for a periodic update date and time, presence or absence of scan settings, settings for a scan date and time, and a pattern file (ver.) are the same as the setting items described in the first embodiment, description thereof is omitted herein.

The predetermined period can be set as necessary according to a set periodic update date and time. For example, in a case where settings for a periodic update date and time is a specified time (daily) such as “yyyy.mm.dd. 16:00”, it is possible to set on an hourly basis such as one hour (h). In addition, as exemplified by a case of an administrator B, in a case where settings for a periodic update date and time are a specified date and time (e.g., the 10th day of each month) such as “yyyy.mm.10. 00:00”, it is possible to set on a daily basis such as one day (24 h).

Note that, the predetermined period according to a periodic update date and time can also be set based on a type of pattern file to be applied to virus scanning. Herein, it is assumed that a pattern file “67890 (ver. 1.0)” to be applied to the administrator B has a longer release interval of a pattern file for updating than that of the pattern file “12345 (ver. 1.1.1)” to be applied to the administrator A. In this case, even when the same periodic update date and time, and the same predetermined period as those for the pattern file “12345 (ver. 1.1.1)” are set, it is highly likely that the pattern file for updating of the pattern file “67890 (ver. 1.0)” has not been released, and the administrator B may fail to update the pattern file. In the predetermined-period-related management table according to the second embodiment, since settings for the periodic update date and time and the predetermined period based on a type of a pattern file to be applied to virus scanning can be individually made, it is possible to perform more optimal update of a pattern file.

Note that, while FIG. 13 is an example of a case where there are three administrators A, B, and C, the number of administrators is not limited thereto, and a setting content is also not limited thereto. Further, it is also possible to set a plurality of parameters regarding the same setting item (e.g., it is possible to set both of the pattern file “12345 (ver. 1.1.1)” and the pattern file “67890 (ver. 1.0)” regarding the pattern file (ver.)). By the way, some or all of the parameters to be set in the predetermined-period-related management table can also be set in advance as initial parameters that cannot be manipulated by the user (administrator).

2.2 Flow of Processing

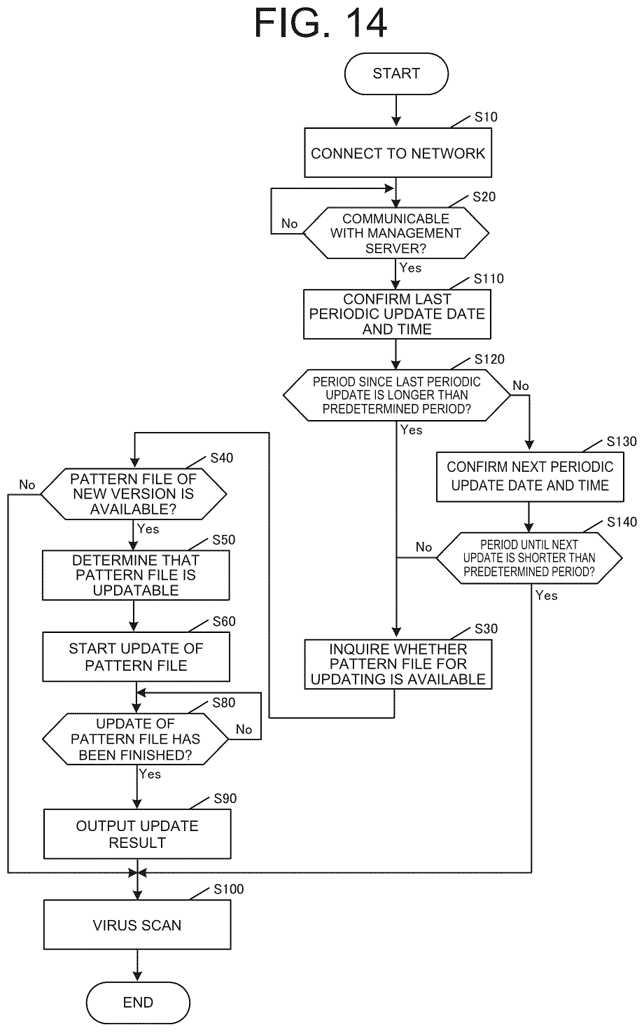

Next, a flow of processing of the multifunction device 10 according to the second embodiment is described by using the flowchart in FIG. 14. Note that, a same step number is attached to a portion of the same processing as the processing described in FIG. 7 of the first embodiment.

When being connected to a network NW1, a controller 11 of the multifunction device determines whether it is possible to communicate with a management server 30 (step S10→step S20). Note that, the controller 11 can recognize connection to the network NW1 by acquiring a connection signal output from a NW connection detector 211. Then, the controller 11 can determine whether it is possible to communicate with the management server 30 by, for example, executing a ping command, based on IP address information and the like of the management server 30 stored in a server information storage area 257.

When it is determined that communication with the management server 30 is possible, the controller 11 checks an update date and time (last periodic update date and time) pertaining to a last periodic update (step S20; Yes→step S110). On the other hand, in a case where it is determined that communication with the management server 30 is not possible, the controller 11 waits until communication with the management server 30 becomes possible (step S20; No).

Next, the controller 11 determines whether a period since the last periodic update date and time is longer than the predetermined period (step S120). In this case, the controller 11 can make the determination in step S120 by computing an elapsed period of time since the last periodic update date and time, and comparing the elapsed period of time with the predetermined period. In a case where the controller 11 determines that the period since the last periodic update date and time is longer than the predetermined period, the controller 11 inquires the management server 30 whether a pattern file for updating is available (step S120; Yes→step S30).

When, as a result of the inquiry to the management server 30, it is determined that there is a pattern file of a new version, the controller 11 determines that the pattern file is updatable (step S40; Yes→step S50). On the other hand, when it is determined that there is no pattern file of a new version, the controller 11 shifts the processing to step S100, and executes virus scanning by using a pattern file (not updated) stored in a pattern file storage area 254 (step S40; No→step S100).

After it is determined that the pattern file is updatable, the controller 11 acquires the pattern file for updating from the management server 30, and starts update of the pattern file (step S60).

Then, the controller 11 determines whether update of the pattern file has been finished (step S80). In a case where it is determined that update of the pattern file has been finished, the controller 11 outputs the update result to the management server 30 (step S80; Yes; →step S90). On the other hand, in a case where it is determined that update of the pattern file has not been finished, the controller 11 continues the processing (step S80; No).

The controller 11 executes virus scanning by using the updated pattern file, and terminates the processing (step S100).

By the way, in a case where the controller 11 determines in step S120 that the period from the last periodic update date and time is shorter than the predetermined period, the controller 11 checks the next periodic update date and time (next periodic update date and time) (step S120; No→step S130). Then, the controller 11 determines whether the period until the next periodic update date and time is shorter than the predetermined period (step S140). In this case, the controller 11 can determine the above by computing an elapsed period of time until the next periodic update date and time, and comparing the elapsed period of time with the predetermined period. In a case where the controller 11 determines that the period until the next periodic update date and time is shorter than the predetermined period, the controller 11 does not update the pattern file. The controller 11 shifts the processing to step S100, and executes virus scanning by using the pattern file (not updated) stored in the pattern file storage area 254 (step S40; No→step S100). On the other hand, in a case where the controller 11 determines that the period until the next periodic update date and time is longer than the predetermined period, the controller 11 shifts the processing to step S30 (step S140; No→step S30).

2.3 Operation Example

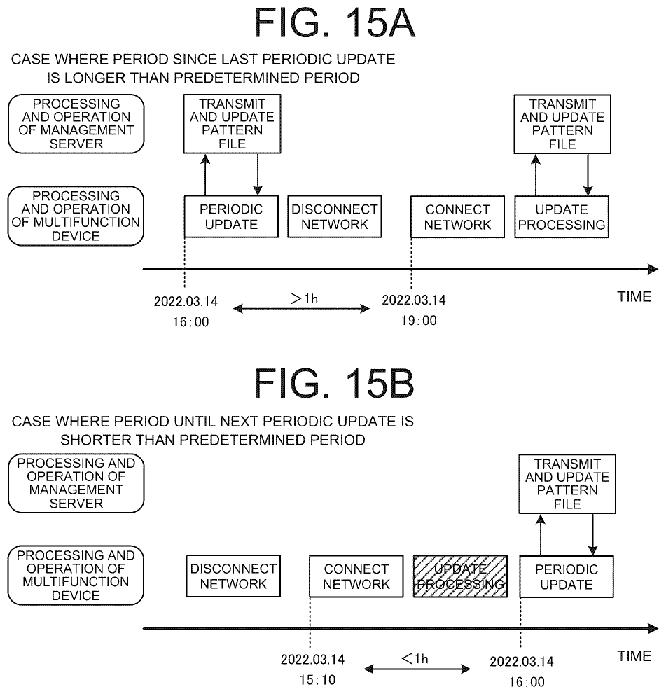

Next, an operation example according to the second embodiment is described. FIGS. 15A and 15B are diagrams conceptually illustrating a timing sequence of processing and operation between the multifunction device 10 and the management server 30 according to the second embodiment.

In FIGS. 15A and 15B, processing and operation of update of a pattern file in a multifunction device 10a is described as an example. Herein, it is assumed that the horizontal axis in FIGS. 15A and 15B indicates an elapse of time (point of time), and processing and operation pertaining to update of a pattern file since “2022.03.14 16:00” is mainly described. In addition, description is made based on a premise that the controller 11 of the multifunction device 10a performs control pertaining to update of a pattern file, based on the parameters set for the administrator A in the predetermined-period-based management table illustrated in FIG. 13.

FIG. 15A is a configuration in a case where a reference update date and time of a pattern file is set as a last periodic update date and time, and a network connection date and time with respect to the last periodic update date and time is longer than the predetermined period. Note that, an operation example described herein is an operation example associated with the processing of step S120; Yes→step S30 in FIG. 14.

In FIG. 15A, it is assumed that periodic update is performed at “2022.03.14 16:00”, and thereafter, network connection is disconnected because of a reason such as a power outage caused by shifting to the energy saving mode, a power outage of the device caused by operating a power switch or the like, or removal of an Ethernet (registered trademark) cable from a connection connector. Then, it is assumed that the multifunction device 10a is connected to the network NW1 at “2022.03.14 19:00”. In this case, three hours (h) longer than the predetermined period (one hour (h)) have passed since “2022.03.14 16:00”, which corresponds to the last periodic update date and time until the multifunction device 10a is connected to the network NW1.

In a case of this example, the controller 11 of the multifunction device 10a performs update of a pattern file by using connection to the network NW1, as a trigger.

On the other hand, FIG. 15B is a configuration of a case where a reference update date and time of a pattern file is set as a next periodic update date and time, and a network connection date and time with respect to the next periodic update date and time is shorter than the set predetermined period. Note that, an operation example described herein is an operation example associated with the processing of step S140; Yes→step S100 in FIG. 14.

In FIG. 15B, it is assumed that, after network connection is disconnected because of a reason such as a power outage caused by shifting to the energy saving mode, a power outage of the device caused by operating a power switch or the like, or removal of an Ethernet (registered trademark) cable from a connection connector, the multifunction device 10a is connected to the network NW1 at “2022.03.14 15:10”. Then, in a case where the next periodic update date and time is “2022.03.14 16:00”, a period since connection to the network NW1 until the next periodic update date and time is shorter than the predetermined period (1 hour (h)).

In this case, the controller 11 of the multifunction device 10a does not perform update of the pattern file by using connection to the network NW1, as a trigger, but performs update of the pattern file waiting for arrival of a periodic update date and time.

As illustrated in FIGS. 15A and 15B, in the second embodiment, in a case where the network connection date and time with respect to the last periodic update date and time is longer than the set predetermined period, control of minimizing a time lag pertaining to update of a pattern file is performed by performing update of the pattern file. On the other hand, in a case where the network connection date and time with respect to the next periodic update date and time is shorter than the set predetermined period, it is possible to suppress overlapping of update of the pattern file in a short time by restricting update of the pattern file.

As described above, according to the second embodiment, in addition to the advantageous effect of the first embodiment, it is possible to determine whether it is necessary to update a pattern file according to determination as to whether the network connection date and time with respect to the reference update date and time of the pattern file is longer or shorter than the set predetermined period, thus enabling appropriate maintenance of the pattern file for virus scanning.

### 3. Third Embodiment

A third embodiment is an embodiment in which, when it is determined that a pattern file is updatable, the user is inquired whether the pattern file is updatable.

3.1 Functional Configuration

Since a configuration of a virus quarantine system, a management server, and a vendor server according to the third embodiment can be made substantially the same as that of the virus quarantine system 100, the management server 30, and the vendor server 50 according to the first embodiment, the same reference sign is attached to the same component, and description of its functional configuration is omitted.

3.1.1 Regarding Multifunction Device 70

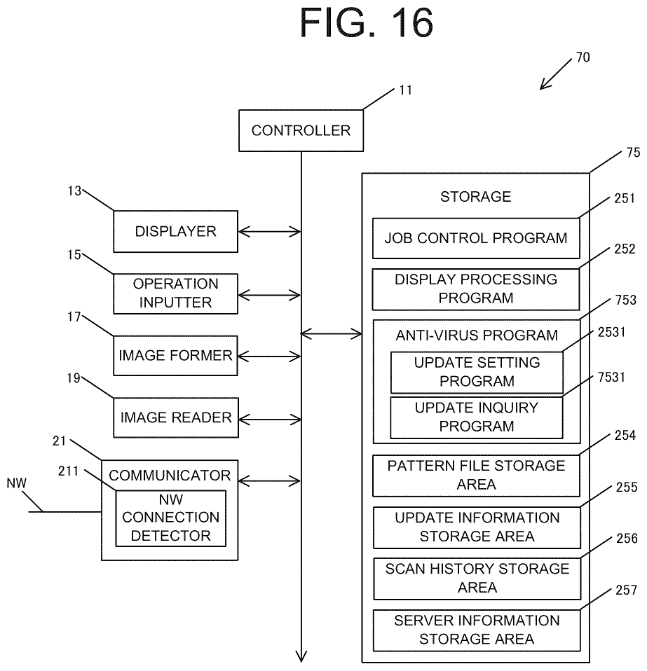

FIG. 16 is a functional configuration diagram of a multifunction device 70 according to the third embodiment. The multifunction device 70 includes a storage 75, in place of the storage 25 of the multifunction device 10 according to the first embodiment.

In the third embodiment, the storage 75 stores therein a job control program 251, a display processing program 252, and an anti-virus program 753, and secures a pattern file storage area 254, an update information storage area 255, a scan history storage area 256, and a server information storage area 257.

The anti-virus program 753 includes an update inquiry program 7531, in addition to an update setting program 2531. The update inquiry program 7531 is a program to be read by a controller 11 when inquiring a user whether a pattern file is updatable.

3.2 Flow of Processing

3.2.1 Flow of Processing of Multifunction device 70

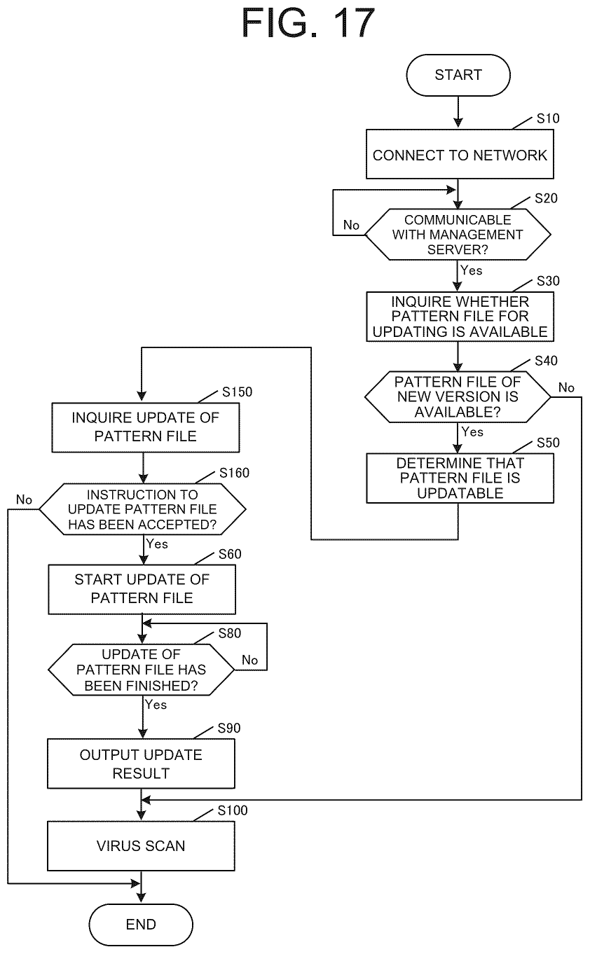

Next, a flow of processing of the multifunction device 70 according to the third embodiment is described by using the flowchart in FIG. 17. The flow of processing of the multifunction device 70 according to the third embodiment includes processing of inquiring the user whether a pattern file is updatable between processing pertaining to determination as to whether the pattern file is updatable in step S50, and processing pertaining to start of update of the pattern file in step S60, which have been described in FIG. 7 of the first embodiment. The other processing can be made the same. Therefore, description on processing that can be made the same is omitted.

When the controller 11 determines that the pattern file is updatable, the controller 11 inquires the user whether to update the pattern file (step S50→step S150).

When receiving an inquiry as to whether the pattern file is updatable, and accepting, from the user, an instruction to update the pattern file, the controller 11 starts update of the pattern file (step S160; Yes→step S60). On the other hand, in a case where an instruction to update the pattern file is not accepted from the user, the controller 11 terminates the processing (step S160; No→end).

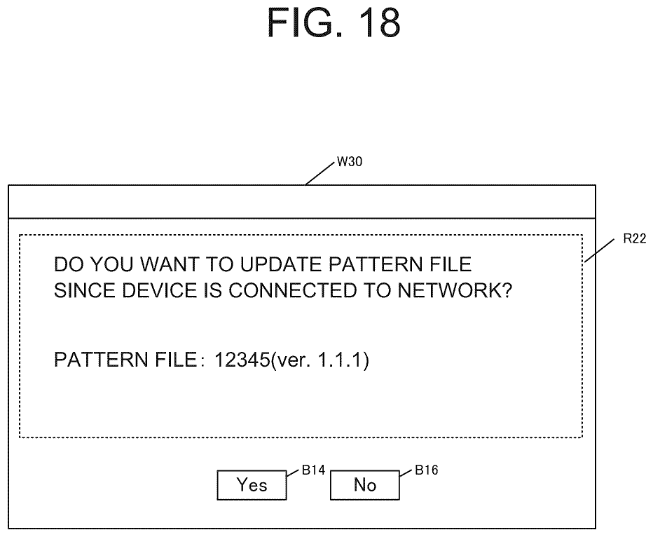

FIG. 18 is a diagram illustrating a configuration example of an inquiry screen W30 to be displayed on a displayer 13 by the controller 11, as an inquiry as to whether a pattern file is updatable. The inquiry screen W30 includes an inquiry content display area R22, a Yes button B14, and a No button B16. Note that, display of the inquiry screen W30 is an operation example associated with the processing of step S150 in FIG. 17.

The inquiry content display area R22 is a display area that displays a content inquiring the user whether the pattern file is updatable. FIG. 18 is an example in which a message “the pattern file: 12345 (ver. 1.1.1)” is displayed in the inquiry content display area R22, as a pattern file pertaining to update, in addition to a message “since the device is connected to the network, do you want to update the pattern file?”, as an inquiry content to the user.

The Yes button B14 is a button that accepts an input of an instruction to update the pattern file by the user. When the Yes button B14 is selected by the user, the controller 11 determines that an instruction to update the pattern file has been accepted (step S160 in FIG. 17; Yes). The No button B16 is a button that accepts a user input as to whether the pattern file is updatable. When the No button B16 is selected by the user, the controller 11 determines that the pattern file is not updatable (step S160 in FIG. 17; No).

As described above, according to the third embodiment, in addition to the advantageous effect of the first embodiment, the user is inquired whether a pattern file is updatable, when it is determined that the pattern file is updatable. This enables to prevent in advance, for example, user's execution of a job from being interfered with by update of a pattern file.

### 4. Fourth Embodiment

A fourth embodiment is an embodiment in which the processing order pertaining to update of a pattern file is controlled according to presence or absence of a job in progress, or a job waiting to be processed.

4.1 Functional Configuration

Since a configuration of a virus quarantine system according to the fourth embodiment can be made substantially the same as that of the virus quarantine system 100 according to the first embodiment, the same reference sign is attached to the same component, and description of its functional configuration is omitted.

4.2 Flow of Processing

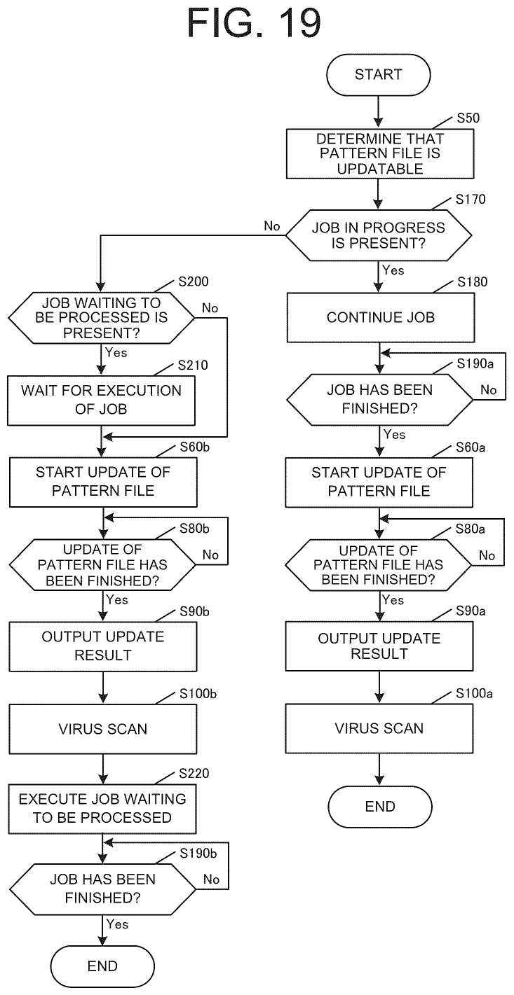

Next, a flow of processing of a multifunction device 10 according to the fourth embodiment is described by using the flowchart in FIG. 19. The flow of processing of the multifunction device 10 according to the fourth embodiment differs from processing after the processing pertaining to determination as to whether a pattern file is updatable in step S50, which has been described in FIG. 7 of the first embodiment. Therefore, processing after step S50 is described.

When a controller 11 determines that a pattern file is updatable, the controller 11 determines whether there is a job in progress (step S50→step 170).

When it is determined that there is a job in progress, the controller 11 continues the job (step S170; Yes→step S180). Subsequently, the controller 11 determines whether the job in progress has been finished (step S190a). When it is determined that the job in progress has been finished, the controller 11 starts update of the pattern file (step S190a; Yes→step S60a). On the other hand, when it is determined that the job in progress has not been finished, the controller 11 continues the processing until the job is finished (step S190a; No).

After determining that the job in progress has been finished, the controller 11 acquires the pattern file for updating from a management server 30, and starts update of the pattern file (step S60a).

Then, the controller 11 determines whether update of the pattern file update has been finished (step S80a). In a case where it is determined that update of the pattern file has been finished, the controller 11 outputs the update result to the management server 30 (step S80a; Yes→step S90a). On the other hand, in a case where it is determined that update of the pattern file has not been finished, the controller 11 continues the processing until the update is finished (step S80a; No).

The controller 11 executes virus scanning by using the updated pattern file, and terminates the processing (step S100a).

By the way, when it is determined that there is no job in progress, the controller 11 determines whether there is a job waiting to be processed (step S170; No→step S200).

When it is determined that there is a job waiting to be processed, the controller 11 waits for execution of the job waiting to be processed (step S200; Yes→step S210). Note that, when it is determined that there is no job waiting to be processed, the controller 11 shifts the processing to step S60b (step S200; No→step S60b).

After waiting for execution of the job, the controller 11 acquires a pattern file for updating from the management server 30, and starts update of the pattern file (step S60b).

Then, the controller 11 determines whether update of the pattern file has been finished (step S80b). In a case where it is determined that update of the pattern file has been finished, the controller 11 outputs the update result to the management server 30 (step S80b; Yes→step S90b). On the other hand, in a case where it is determined that update of the pattern file has not been finished, the controller 11 continues the processing until the update is finished (step S80a; No).

The controller 11 executes virus scanning by using the updated pattern file (step S100b). At this occasion, the controller 11 successively and preferentially executes virus scanning with respect to a job waiting to be processed.

Subsequently, the controller 11 executes jobs as needed preferentially from a job in which virus scanning has been completed (step S220). The controller 11 determines whether the job in progress has been finished (step S190b). When it is determined that the job in progress has been finished, the controller 11 terminates the processing (step S190b; Yes→end). Note that, when it is determined that the job has not been finished, the controller 11 continues the processing until the job is finished (step S190b; No).

Note that, in step S210, the user (administrator) may select which is preferentially executed, a job waiting to be processed, or update of a pattern file. In addition, a job that is continued to be executed, and a job waiting to be executed may be sorted according to the type of a job. For example, since a print job, a fax job, and the like that have been received from an external device are jobs to be executed via a network, these jobs are considered to have a high risk of virus infection. Jobs as described above may be set as jobs waiting to be executed, and since jobs that are completed within the multifunction device 10, for example, such as a scan job and a copy job are considered to have a low risk of virus infection, these jobs may be sorted as jobs whose execution is continued.

As described above, according to the fourth embodiment, in addition to the advantageous effect of the first embodiment, it is possible to maximally provide an advantageous effect of virus checking, while minimizing an influence of a job that executes processing on a user operation.

The present disclosure is not limited to the above-described embodiments, and various changes are available. Specifically, embodiments to be acquired by appropriately combining modified technical means within a range that does not depart from the gist of the present disclosure are also included in the technical scope of the present disclosure.

In addition, some of the above-mentioned embodiments are described separately for convenience of explanation, but it is of course possible to combine the embodiments within a technically available range. Note that, in the present embodiment, the multifunction device acquires a pattern file for updating from the management server, but it is of course possible for the multifunction device to directly acquire a pattern file for updating from the vendor server.

In addition, a program operating in each device in the embodiments is a program (a program causing a computer to function) that controls a CPU or the like in such a way as to achieve functions of the above-described embodiments. Further, the embodiments have been described based on a premise that a plurality of programs are simultaneously executed as necessary by multi-task processing. Further, information to be handled by these devices is temporarily stored in a temporary storage device (e.g., a RAM) at a time of the processing, and thereafter, is stored in a storage device such as various read only memories (ROMs), and HDDs, and is read and corrected/written by the CPU as necessary.

Herein, a recording medium for storing the program may be any of a semiconductor medium (e.g., a ROM, a non-volatile memory card, and the like), an optical recording medium/magneto-optical recording medium (e.g., a digital versatile disc (DVD), a magneto optical disc (MO), a mini disc (MD), a compact disc (CD), a Blu-ray (registered trademark) disc (BD), and the like), a magnetic recording medium (e.g., a magnetic tape, a flexible disk, and the like), and the like. In addition, not only functions of the above-described embodiments are achieved by executing a loaded program, but also functions of the present disclosure may be achieved by processing the program jointly with an operating system, other application program, or the like, based on an instruction of the program.

Further, in a case of distributing the program in the market, the program can be stored in a portable recording medium and distributed, or can be transferred to a server computer connected via a network such as the Internet. In this case, it is needless to say that a storage device of the server computer is also included in the present disclosure.

What is claimed is:

1. An image forming apparatus comprising:
a controller that executes virus quarantine using a pattern file; and
a storage that stores the pattern file, wherein
the controller determines, when being connected to a network, whether the pattern file stored in the storage is updatable, and when it is determined that the pattern file is updatable, the controller updates the pattern file, and executes virus quarantine by using the updated pattern file.

2. The image forming apparatus according to claim 1, wherein
the controller, when being connected to the network, updates the pattern file, in a case where an elapsed period of time since a last executed update of the pattern file is longer than a predetermined period.

3. The image forming apparatus according to claim 1, wherein
the controller, when being connected to the network, updates the pattern file, in a case where a period until a next scheduled update of the pattern file is longer than a predetermined period.

4. The image forming apparatus according to claim 3, wherein
the controller, when being connected to the network, restricts update of the pattern file, in a case where a period until the next update is shorter than a predetermined period.

5. The image forming apparatus according to claim 1, wherein
in a case where it is determined that the pattern file is updatable, the controller inquires a user whether the pattern file is updatable.

6. The image forming apparatus according to claim 1, further comprising
a job executor that executes a job pertaining to image forming, wherein
in a case where the job executor is executing the job, the controller updates the pattern file after execution of the job.

7. The image forming apparatus according to claim 6, wherein
in a case where the job waiting to be processed is present, the controller updates the pattern file, and executes the job waiting to be processed after executing virus quarantine by using the updated pattern file.

8. A virus quarantine system comprising:
a server that provides a pattern file; and
an image forming apparatus that acquires the pattern file via a network, wherein
the image forming apparatus includes
a controller that executes virus quarantine using the pattern file, and
a storage that stores the pattern file,
the controller, when being connected to a network, determines whether the pattern file stored in the storage is updatable, and when it is determined that the pattern file is updatable, the controller updates the pattern file, and executes virus quarantine by using the updated pattern file, and
the server stores an update history on the pattern file in the image forming apparatus.

9. A virus quarantine method comprising:
executing virus quarantine by using a pattern file; and
storing the pattern file; and
determining whether the stored pattern file is updatable when connection to a network is made, and updating the pattern file and executing virus quarantine by using the updated pattern file when it is determined that the pattern file is updatable.
